(19) United States
(12) Patent Application Publication
(10) Pub. No.: US 2005/0150929 A1
(43) Pub. Date: Jul. 14, 2005

(54) Nailer magazine

(76) Inventor: Fwu-Lai Wey, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/026,867

(22) Filed: Dec. 30, 2004

(30) Foreign Application Priority Data
Jan. 9, 2004 (TW) 093200451

(51) Int. Cl. B25C 5/02

(52) U.S. Cl. 227/120; 227/109

(57) ABSTRACT

A nailer magazine includes a stator stably mounted on a bottom of a striking portion of a body of the nailer and a slider longitudinally slidably mounted to the stator. A feeding device is mounted between the stator and the slider for pushing staples. A backward device is mounted in the stator. The backward device makes the feeding device in a backward condition when detaching the slider from the stator and in an inward condition for stably holding the staples when mounting the slider after the slider contacting with a valve that is mounted in a bottom of the body of the nailer.

### BACKGROUND OF THE INVENTION

1. Field of the Invention

The present invention relates to a nailer magazine, and more particularly to a nail magazine, which is provided for preventing nails from being transformed.

2. Description of Related Art

A conventional nailer magazine in accordance with the prior art comprises a stator mounted on a striking portion of the nailer and a slider slidably mounted on the stator. A feeder with a pusher is disposed on the slider. The pusher uses the restitution force of a resilient element to pushing the staples. The distal end of the pusher always extends over the outer periphery of the slider when detaching or snapping the conventional nailer magazine. Consequently, the user previously arranges the staples that are linearly correspond to the stator and the pusher previously straightly pushes the staples when mounting the magazine.

However, the staples are in a free condition when the pusher firstly contacts with the staples. Consequently, the staples may be transformed or upwardly extend due to an improper action for mounting the conventional magazine. As a result, the staples may be wedged during operating the nailer.

The present invention has arisen to mitigate and/or obviate the disadvantages of the conventional nailer magazine.

### SUMMARY OF THE INVENTION

The main objective of the present invention is to provide an improved nailer magazine for preventing the staples from being transformed and wedged during operating the nailer.

To achieve the objective, the nailer magazine in accordance with the present invention comprises a stator stably mounted on a bottom of a striking portion of a body of the nailer and a slider longitudinally slidably mounted to the stator. A feeding device is mounted between the stator and the slider for pushing staples. A backward device is mounted in the stator. The backward device makes the feeding device in a backward condition when detaching the slider from the stator and in an inward condition for stably holding the staples when mounting the slider after the slider contacting with a valve that is mounted in a bottom of the body of the nailer. The reload staples are previously limited between the stator and the slider to prevent the reload staples from being transformed when the feeding device firstly contact with the reloaded stapes.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a nailer magazine in accordance with the present invention;

FIG. 2 is a perspective view of a nailer magazine in accordance with the present invention;

FIG. 3 is a front cross-sectional view of the nail magazine in FIG. 2;

FIG. 4 is a side schematic view in partial cross-section of a nailer with the nailer magazine in FIG. 2 when feeding staples;

FIG. 4A is a partial enlarged view of the nailer in FIG. 4;

FIG. 5 is a side cross-sectional view of the nailer magazine in FIG. 2 when feeding staples;

FIG. 6 is a partial enlarged view of the nailer in FIG. 4 when detaching the nailer magazine; and

FIG. 7 is a side cross-sectional view of the nailer magazine in FIG. 2 when being detached from the nailer.

### DETAILED DESCRIPTION OF THE INVENTION

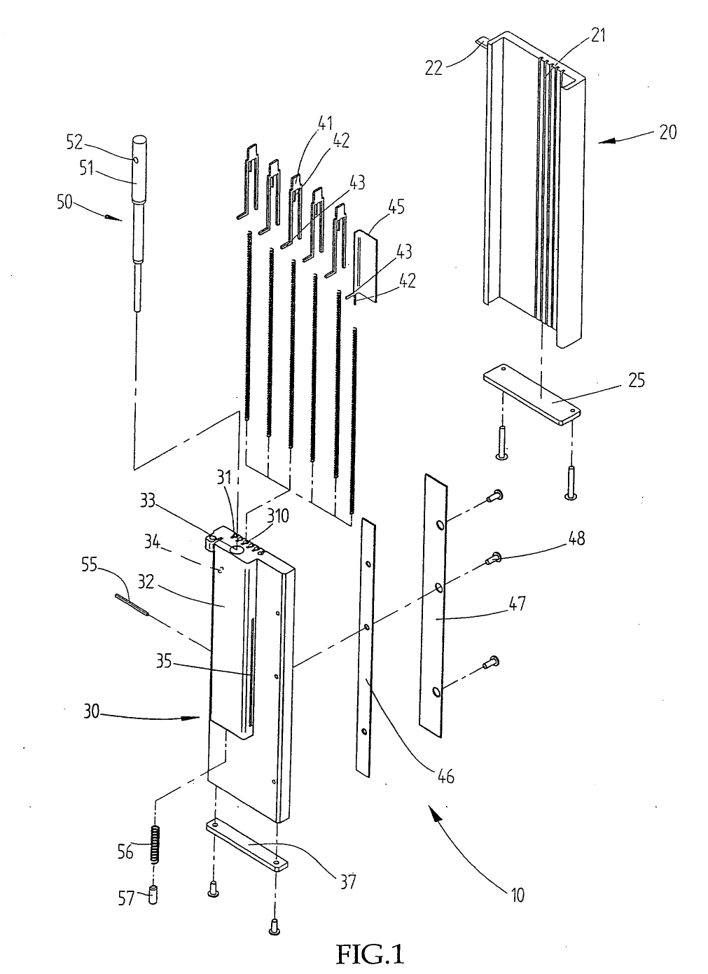

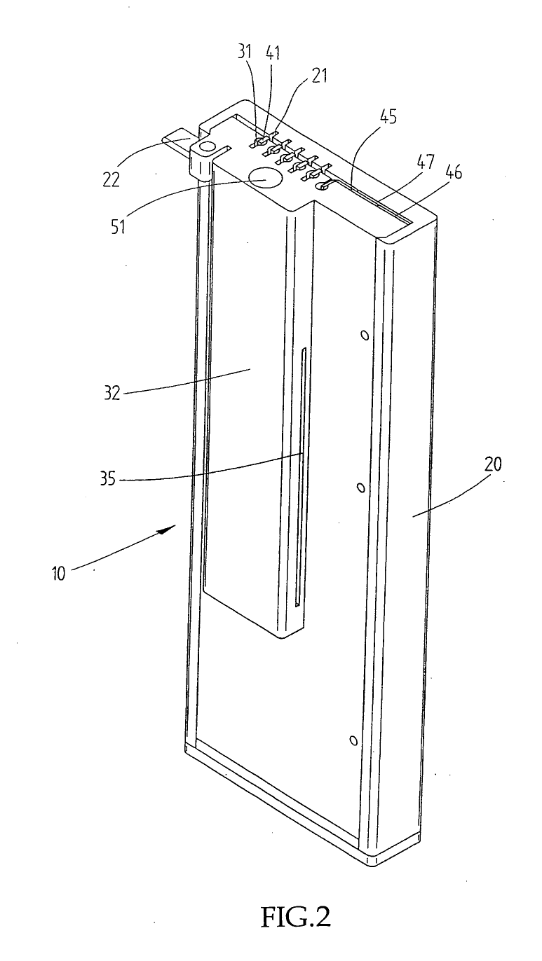

Referring to the drawings and initially to FIGS. 1, 2 and 4, a nailer magazine (10) in accordance with the present invention comprises a stator (30) stably mounted on a bottom of a striking portion (65) of a body (60) of the nailer and a slider (20) longitudinally slidably mounted to the stator (30). A feeding device (40) is mounted between the stator (30) and the slider (20) for pushing staples. A backward device (50) is mounted in the stator (30). The backward device (50) makes the feeding device (40) in a backward condition when detaching the slider (20) from the stator (30) and in an inward condition for stably holding the staples when mounting the slider (20) after the slider (20) contacting with a valve (70) that is mounted in a bottom of the body (60) of the nailer.

With reference to FIGS. 1-3, the slider (20) has a U-shaped cross-section, and multiple grooves (21) respectively longitudinally defined in an inner periphery of the slider (20) and facing the stator (30). A contacting plate (22) laterally extends from one side of the slider (20) and contacts with the valve (70) after slidably mounting the slider (20) to the stator (30). A bottom plate (25) is securely mounted to a lower end of the slider (20) for closing the lower distal end of the slider (20).

The stator (30) includes multiple grooves (31) longitudinally defined in one side thereof. Each groove (31) in the stator (30) communicates with a corresponding one of the multiple grooves (21) in the slider (20). Each groove (31) has an enlarged portion (310) longitudinally formed in a middle portion of each of the groove (31) in the stator (30). A block (32) extends from the stator (30) opposite to the slider (20). A sunken hole (33) is longitudinally defined in and extends through the block (32). The sunken hole (33) is divided into three sections each having a diameter enlarged due to a height thereof. An inlet (34) is defined in the block (32) and laterally communicates with the sunken hole (33). The block (32) includes a slot (35) longitudinally defined therein and laterally communicating with the sunken hole (33) for guiding the backward device (50). A bottom plate (37) is securely mounted to a lower end of the stator (30) for closing the multiple grooves (31) in the stator (30).

The feeding device (40) includes multiple U-shaped pushers (41) having two opposite ends respectively received in a corresponding one of the grooves (31, 21) in the stator (30) and the slider (20). Each pusher (41) has an insertion (42) extending therefrom for inserting into a spring (44) that is longitudinally received in the enlarged portion (310) of the corresponding one of the grooves (31) in the stator (30). A rod (43) laterally perpendicularly extends from the pusher (41) and received in the slot (35) to make the backward device (50) drive the pusher (41) of the deeding device (40). A pushing plate (45) is received in the last grooves (31, 21) of the stator (30) and the slider (20) for limiting a thickness of the staples. Two plates (46, 47) are respectively secured on two opposite sides of the stator (30) by multiple bolts (48) to form a gap between the stator (30) and the slider (20) for receiving the pushing plate (45). The structure of the pushing plate (45) is similar to that of the pusher (41), and has an insertion (42) and a rod (43) extending from the pushing plate (45).

The backward device (50) includes a shaft (51) reciprocally movably received in the sunken hole (33). The shaft (51) has a shape corresponding to that of the sunken hole (33). A through hole (52) is diametrically defined in the shaft (51) and selectively communicates with the inlet (34). A lateral rod (55) extends through the multiple pushers (41) and secured on a lower end of the shaft (51) to backward push the multiple pushers (41). A restitution spring (56) is received in a lower end of the sunken hole (33) and a stopper (57) is secured received in the lower end of the sunken hole (33) to prevent the restitution spring (56) from detaching from the stator (30). The restitution spring (56) is disposed to provide a restitution force for the shaft (51).

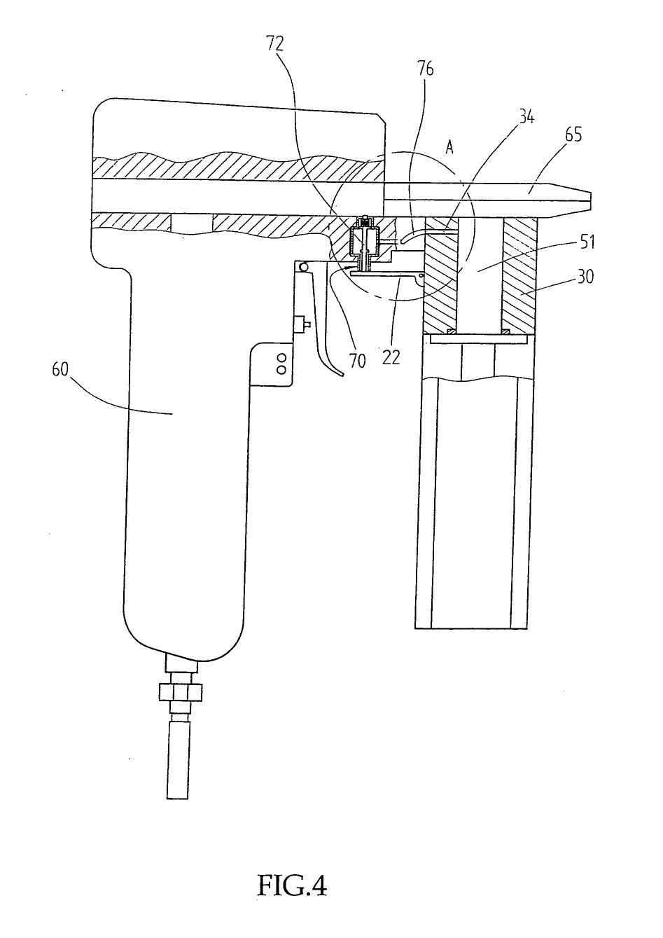

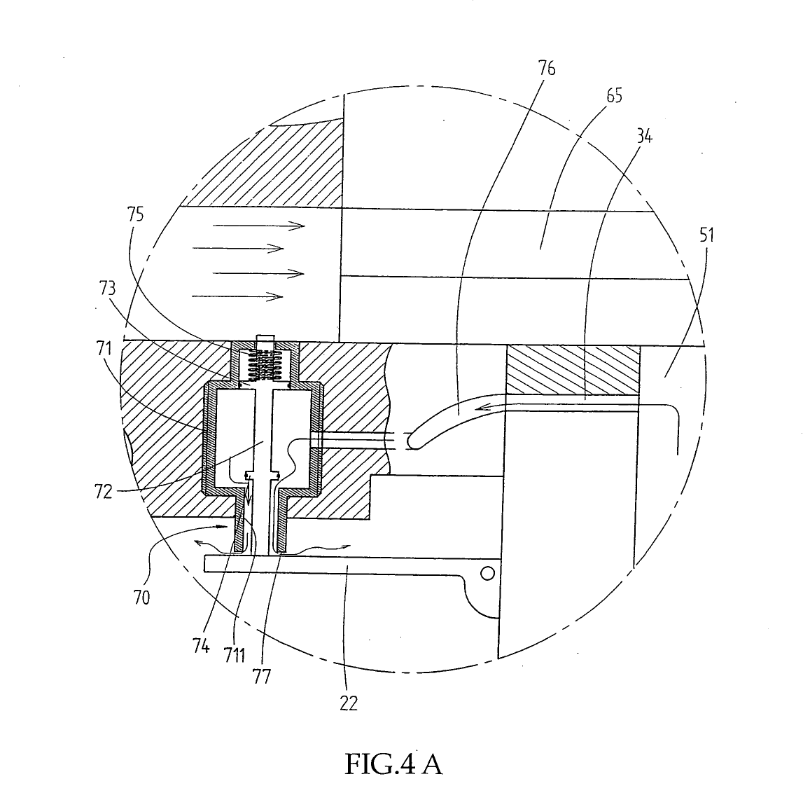

With reference to FIG. 4A, the valve (70) includes a hollow main body (71) with an upper passage (not numbered) and a lower passage (711) longitudinally corresponding to each other. An actuated rod (72) is movably received in the main body (71). The actuated rod (72) has a first flange (73) and a second flange (74) respectively radially extending therefrom for selectively closing the upper passage and the lower passage (711). A resilient member (75) is sleeved on an upper portion of the actuated rod (72) for providing a restitution force to the actuated rod (72) after the actuated rod (72) being upwardly pushed. An air path (76) is defined in the body (60) of the nailer and communicates with the upper passage and the inlet (34) in the stator (30).

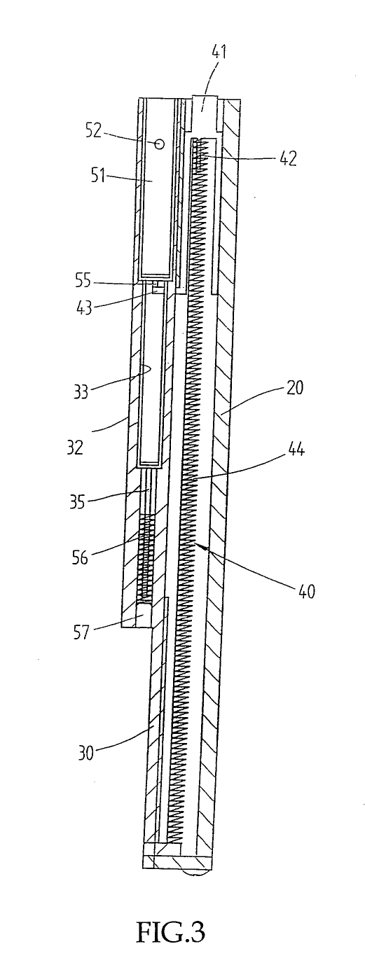

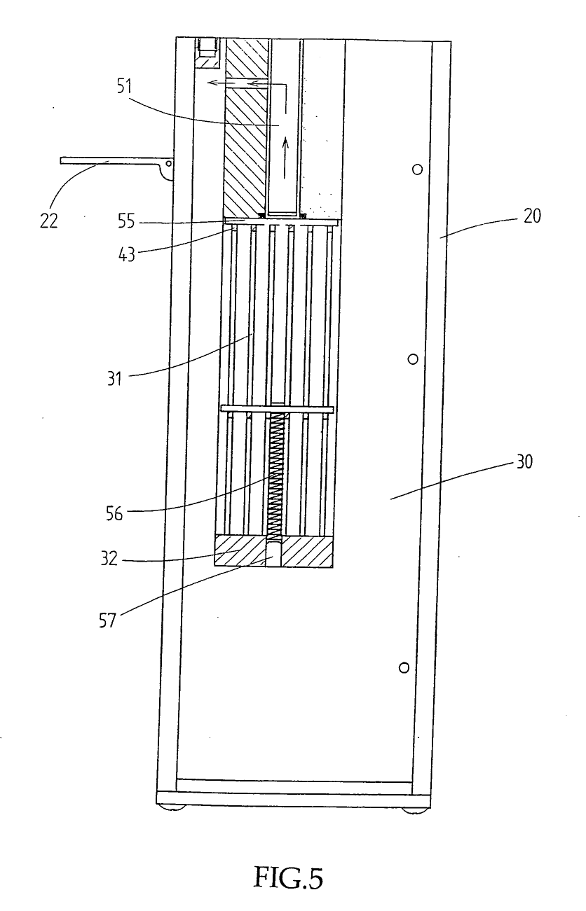

With reference to FIGS. 3-5, the contacting plate (22) of the slider (20) upwardly pushes the actuated rod (72) for compressing the resilient member (75) to make the first flange (73) airtightly closing the upper passage of the valve (70) and forming a gap (77) between the contacting plate (22) and the main body (71) of the valve (70) when the staples is disposed in the nailer magazine (10) and the slider (20) is upwardly pushed and in a forward condition. As a result, the compressed air in the stator (30) is exhausted via the lower passage (711) of the valve (70) and the gap (77) between the contacting plate (22) and the main body (71) of the valve (70), and then the shaft (51) is a free condition. Consequently, the restitution spring (56) upwardly pushes the lateral rod (55) and the shaft (51) to make the rod (43) of each of the multiple pushers (41) be disengaged to the lateral rod (55). As a result, the springs (44) upwardly push the multiple pushers (41) for feeding.

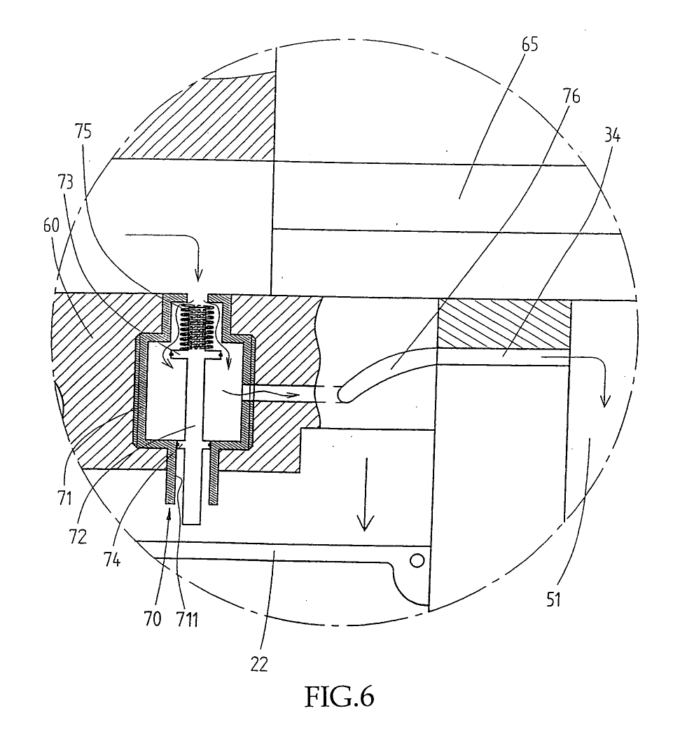

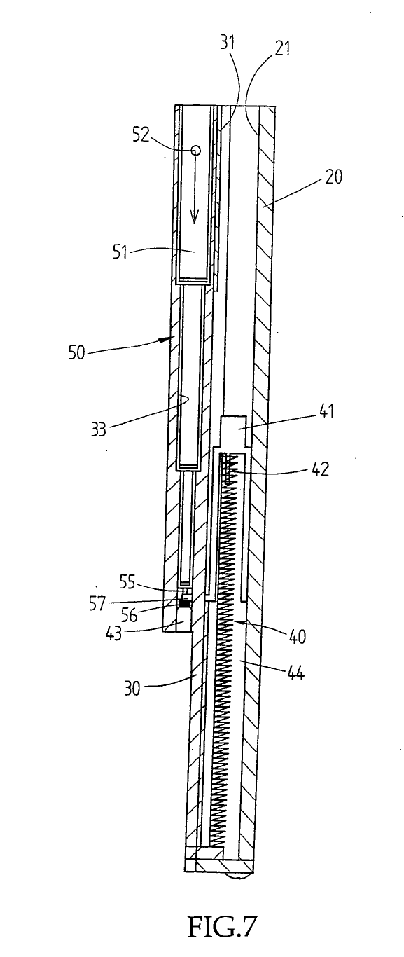

With reference to FIGS. 6 and 7, the contacting plate (22) of the slider (20) is moved away from the actuated rod (72) and the actuated rod (72) is downwardly moved relative to the restitution force of the resilient member (75) to make the second flange (74) airtightly close the lower passage (711) when the slider (20) is downward moved and in a backward condition. The compressed air flows into the valve (70) and the shaft (51) via the inlet (34) and through hole (51) to make the lateral rod (55) downward push the multiple pusher (41) and the and the pushing plate (45). As a result, the feeding device (40) is in a backward condition.

As described above, the slider (20) and the feeding device (40) are in a backward condition when reloading the staples. Consequently, the multiple pushers (41) do not push the staples at the first time. The staples are limited between the stator (30) and the slider (20) when the contacting plate (22) pushes the actuated rod (72) to exhaust the compressed air in the shaft (55) for making the multiple pushers (41) feed stapes. As a result, the reloaded staples do not be transformed when the multiple pushers (41) firstly contact with the reloaded stapes.

Although the invention has been explained in relation to its preferred embodiment, it is to be understood that many other possible modifications and variations can be made without departing from the spirit and scope of the invention as hereinafter claimed.

1. A nailer magazine comprises stator adapted to be stably mounted on a bottom of a striking portion of a body of the nailer and a slider longitudinally slidably mounted to the stator, a feeding device mounted between the stator and the slider for pushing staples, a backward device is mounted in the stator, the backward device making the feeding device in a backward condition when detaching the slider from the stator and in an inward condition for stably holding the staples when mounting the slider after the slider contacting with a valve that is mounted in a bottom of the body of the nailer, the reload staples previously limited between the stator and the slider to prevent the reload staples from being transformed when the feeding device firstly contact with the reloaded stapes.

2. The nailer magazine as claimed in claim 1, wherein the slider includes a multiple grooves respectively longitudinally defined in an inner periphery of the slider and facing the stator, and the stator includes multiple grooves longitudinally defined in one side thereof, each groove in the stator communicates with a corresponding one of the multiple grooves in the slider, the feeding received in the grooves in the stator and the slider.

3. The nail magazine as claimed in claim 2, wherein the feeding device includes multiple U-shaped pushers having two opposite ends respectively received in a corresponding one of the grooves in the stator and the slider, a rod laterally perpendicularly extending from the pusher to make the backward device drive the pusher of the deeding device, a pushing plate received in the last grooves of the stator and the slider for limiting a thickness of the staples.

4. The nailer magazine as claimed in claim 3, wherein two plates are respectively secured on two opposite sides of the stator by multiple bolts to form a gap between the stator and the slider for receiving the pushing plate, the structure of the pushing plate being similar to that of the pusher, and having a rod extending from the pushing plate.

5. The nailer magazine as claimed in claim 3, wherein each groove in the stator has an enlarged portion longitudinally formed in a middle portion of each of the groove in the stator for receiving a spring that provides a restitution force to a corresponding of the multiple pusher and the pushing plate.

6. The nailer magazine as claimed in claim 3, wherein a block extends from the stator opposite to the slider, a sunken hole longitudinally defined in and extending through the block, the sunken hole divided into three sections each having a diameter enlarged due to a height thereof, an inlet defined in the block and laterally communicating with the sunken hole, the block including a slot longitudinally defined therein and laterally communicating with the sunken hole for guiding the backward device,

7. The nailer magazine as claimed in claim 2, wherein the stator includes a bottom plate securely mounted to a lower end of the stator for closing the multiple grooves in the stator.

8. The nailer magazine as claimed in claim 6, wherein the backward device includes a restitution spring received in a lower end of the sunken hole and a stopper secured received in the lower end of the sunken hole to prevent the restitution spring from detaching from the stator, the restitution spring disposed to provide a restitution force for the shaft.
